(19) United States
(12) Patent Application Publication
(10) Pub. No.: US 2025/0348250 A1
(43) Pub. Date: Nov. 13, 2025

(54) NON-TRANSITORY COMPUTER-READABLE STORAGE MEDIUM STORING INSTRUCTIONS IMPLEMENTING SUPPORTING PROGRAM

(71) Applicant: BROTHER KOGYO KABUSHIKI KAISHA, Nagoya (JP)

(72) Inventors: Kenju NARITA, Nagoya (JP); Yoshito HOSOMIZO, Konan (JP); Yushi ICHIKAWA, Nagoya (JP); Airi EGUCHI, Ichinomiya (JP)

(21) Appl. No.: 19/272,977

(22) Filed: Jul. 17, 2025

Related U.S. Application Data
(63) Continuation of application No. PCT/JP2024/000573, filed on Jan. 12, 2024.

(30) Foreign Application Priority Data
Jan. 18, 2023 (JP) 2023-005833

(51) Int. Cl. G06F 3/12

(52) U.S. Cl. CPC G06F 3/1206; G06F 3/1245; G06F 3/1253; G06F 3/1267

(57) ABSTRACT

A supporting program for a printer, when executed by a controller of an information processing device, causes the information processing device connectable to the printer, in a case where the supporting program receives, from a universal printing program, intermediate data representing an image to be printed based on a print instruction in response to the universal printing program receiving the print instruction from an application program, to obtain image data in a specific file format different from a file format of the intermediate data, store the image data in the specific file format in a predetermined storage area, and cause the printer to print the image to be printed based on the intermediate data.

### SPECIFICATION

### REFERENCE TO RELATED APPLICATIONS

This is a continuation application of International Application No. PCT/JP2024/000573 filed on Jan. 12, 2024, which claims priority from Japanese Patent Application No. 2023-005833 filed on Jan. 18, 2023. The entire contents of the aforementioned applications are incorporated herein by reference.

### BACKGROUND ART

Some known techniques have been developed for controlling a printer using an information processing device, such as a personal computer. For example, one technique involves storing an image file representing an image to be printed in response to an print instruction, using an archiving function of a printer driver provided by a printer vendor.

### SUMMARY

Another technique may involve controlling a printer using an OS-standard universal printing program that is part of an operating system (OS), without a printer driver provided by a printer vendor. More specifically, for example, in response to detecting a printer, the OS may establish association between the printer and the OS-standard universal printing program. Thereafter, in response to the OS receiving a print instruction for the printer, the OS-standard universal printing program may generate print data without a printer driver provided by a printer vendor, thereby enabling printing through the OS-standard universal printing program.

Nevertheless, the OS-standard universal printing program might not have a function of storing an image file representing an image to be printed in response to a print instruction. Such a printing environment may cause inconvenience to a user.

According to an aspect of the disclosure, a non-transitory computer-readable storage medium for an information processing device is provided, which includes a controller and stores computer-executable instructions that are executable by the controller. The computer-executable instructions implement a supporting program for a printer connectable to the information processing device. The information processing device has an operating system including a universal printing program. The information processing device is incorporated with an application program. In a case where the supporting program receives, from the universal printing program, intermediate data representing an image to be printed based on a print instruction in response to the universal printing program receiving, from the application program, the print instruction that causes the printer to perform printing, the supporting program, when executed by the controller, causes the information processing device to perform obtaining image data in specific file format based on the intermediate data, the image data representing the image to be printed, the specific file format being different from a file format of the intermediate data, storing the image data in the specific file format in a predetermined storage area, and causing the printer to print the image to be printed based on the intermediate data.

In response to the universal printing program receiving a print instruction from the application program included in an operating system, the supporting program causes the information processing device to cause the printer to print an image to be printed based on intermediate data representing the image to be printed and also obtain image data in a specific file format based on the intermediate data and store the image data in the predetermined store area. With this configuration, even when the information processing device has the OS-standard universal printing program but does not have a printer driver, the information processing device can store an image file representing printout.

Information processing devices having the supporting program is installed, non-transitory computer-readable storage media storing the supporting program, control methods for implementing the functions of the supporting program, and printing systems including the supporting program and a printer may also have novelty and utility.

According to aspects of the disclosure, a technique of storing an image file representing an image to be printed in response to a print instruction may be implemented in an information processing device in which an OS-standard universal printing program is installed.

### BRIEF DESCRIPTION OF THE DRAWINGS

FIG. 1 is a block diagram schematically illustrating an electrical configuration of a personal computer.

FIG. 2A is a sequence diagram illustrating an example of a print settings specifying procedure. FIG. 2B is a continuation of FIG. 2A.

FIG. 3 illustrates an example of a print settings screen.

FIG. 4 illustrates an example of an option settings screen.

FIG. 5 is a sequence diagram illustrating an example of a print execution procedure.

FIG. 6 is a flowchart illustrating an example of Print Archive processing.

FIG. 7 is a sequence diagram illustrating an example of a print execution procedure.

### DESCRIPTION

Hereinafter, a personal computer (“PC”) using a supporting program of an illustrative embodiment will be described in detail with reference to the accompanying drawings. The disclosure discloses the supporting program executed by the PC.

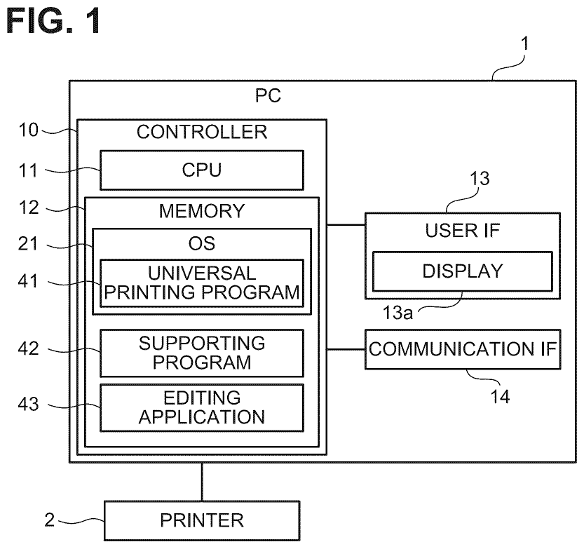

As illustrated in FIG. 1, a PC 1 of the illustrative embodiment includes a controller 10 including a CPU 11 and a memory 12. The PC 1 is an example of an information processing device. The CPU 11 is an example of a computer. The PC 1 includes a user interface (“user IF”) 13 and a communication interface (“communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and data. The memory 12 also serves as a workspace for processing. A buffer of the CPU 11 is an example of the memory 12. Examples of the memory 12 further include storage media readable and writable by the CPU 11, for example, recording media such as CD-ROMs and DVD-ROMs, as well as a ROM, a RAM, a hard disk drive built in the PC 1.

The user IF 13 includes a display 13a, which is hardware for displaying information to a user. Further, the user IF 13 includes hardware for user input. In one example, the user IF 13 may be a combination of the display 13a and an input device, such as a mouse and/or a keyboard. In another example, the user IF 13 may be a touch screen having both display and input functions.

The communication IF 14 includes hardware that enables the PC 1 to communicate with an external device such as the printer 2. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various data and programs, including an operating system (“OS”) 21, a supporting program 42, and an editing application 43. The OS 21 includes a universal printing program 41. The supporting program 42 is an example of a supporting program. The editing application 43 is an example of an application program.

The OS 21 may be a multitasking OS that manages multiple tasks and switches between the multiple tasks, thereby handling several tasks simultaneously. The OS 21 may be, for example, Windows, macOS, Linux, iOS, or Android. Windows is a trademark of the Microsoft group of companies. macOS is a trademark of Apple Inc., registered in the U.S. and other countries and regions. Linux is the registered trademark of Linus Torvalds in the U.S. and other countries. IOS is a trademark or registered trademark of Cisco Systems, Inc. in the U.S. and other countries and is used under license. Android is a registered trademark of Google LLC. The OS 21 includes the universal printing program 41. The universal printing program 41 is an OS-standard program that is developed by a vendor of the OS 21 and provided as part of the OS 21. The universal printing program 41 is designed to allow for the absence of printer-specific drivers.

The universal printing program 41 enables various types and models of printers provided by different vendors to perform printing based on user instructions. The universal printing program 41 supports general functions that enable various printers to perform printing. Unlike printer-specific drivers, the universal printing program 41 does not support a specific function that a printer or printer driver has, in particular, a function requiring complicated processing.

The universal printing program 41 includes a function of generating intermediate image data based on image data received as data to be printed that has been specified in a print instruction received from an application, based on a user instruction. The intermediate image data may be, for example, data in XPS format. “XPS” is an abbreviation for XML Paper Specification. The universal printing program 41 further has a function of generating print data in a format available for printing by various types of printers based on the intermediate image data. The print data may be, for example, PWG Raster data or PDF data. The universal printing program 41 further has a function of transmitting the generated print data to a printer designated as a device for printing, using a communication function of the OS 21.

The supporting program 42 consists of a single program or a group of programs that execute processing based on an instruction received from the OS 21 in association with the processing executed by the universal printing program 41, and that support control of target hardware. The supporting program 42 is provided for the model of the printer 2 connected to the PC 1, for example, by the vendor of the printer 2. The universal printing program 41 activates the supporting program 42 for the printer 2 based on a specific condition. The specific condition may be, for example, the designation of the printer 2 as a device for printing, the reception of an instruction to specify advanced print settings while the printer 2 is designated, or the reception of an instruction to cause the printer 2 to perform printing. The supporting program 42 may be, for example, a Print Support Application (“PSA”) or a Hardware Support Application (“HSA”).

In one example, the supporting program 42 may be a combination of a plurality of programs that receive execution commands, respectively. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models.

For example, when a particular printer is connected to the PC 1 for the first time, the OS 21 of the PC 1 may download a supporting program appropriate for the type or model of the printer from a server of the vendor of the printer, and install the supporting program on the PC 1. The OS 21 stores identification data of the installed supporting program into the memory 12 in association with printer data of the newly connected printer.

The editing application 43 may be, for example, a program for creating and editing image data and/or document data. The editing application 43 may be, for example, Microsoft Word or Microsoft PowerPoint developed by Microsoft or may be a program provided by the vendor of the printer 2. Microsoft, Microsoft PowePoint, and Microsoft Word are trademarks of the Microsoft group of companies. The editing application 43 may receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user's request.

As illustrated in FIG. 1, the PC 1 of the illustrative embodiment is connected to the printer 2 via the communication IF 14. The printer 2 has at least a printing function and a communication function. For example, in response to receiving print data from the PC 1, the printer 2 may perform printing based on the received print data.

Next, a printing procedure performed by the PC 1 of the illustrative embodiment will be described with reference to sequence diagrams. Processing executed in each step in the illustrative embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms referring to coming into possession are used as a concept that does not require necessarily a request to obtain that possession.

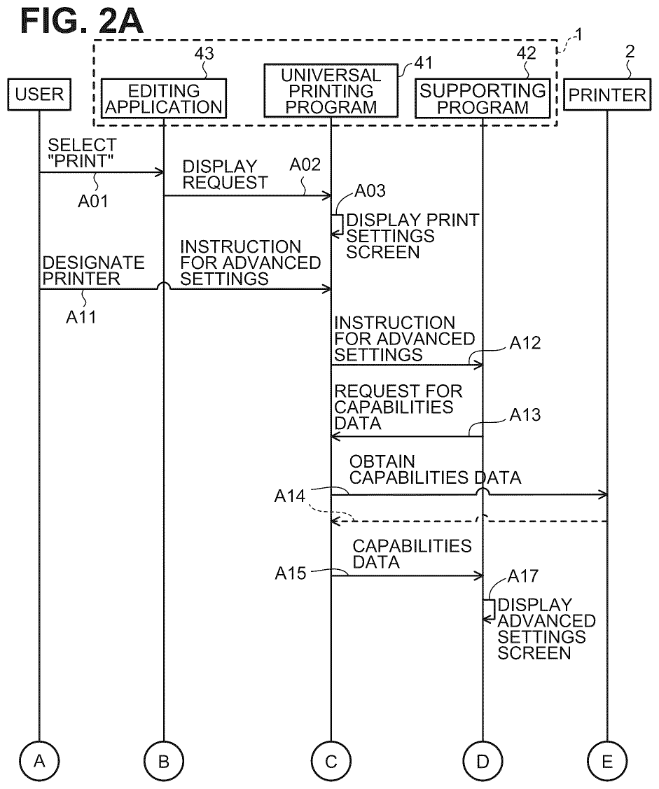

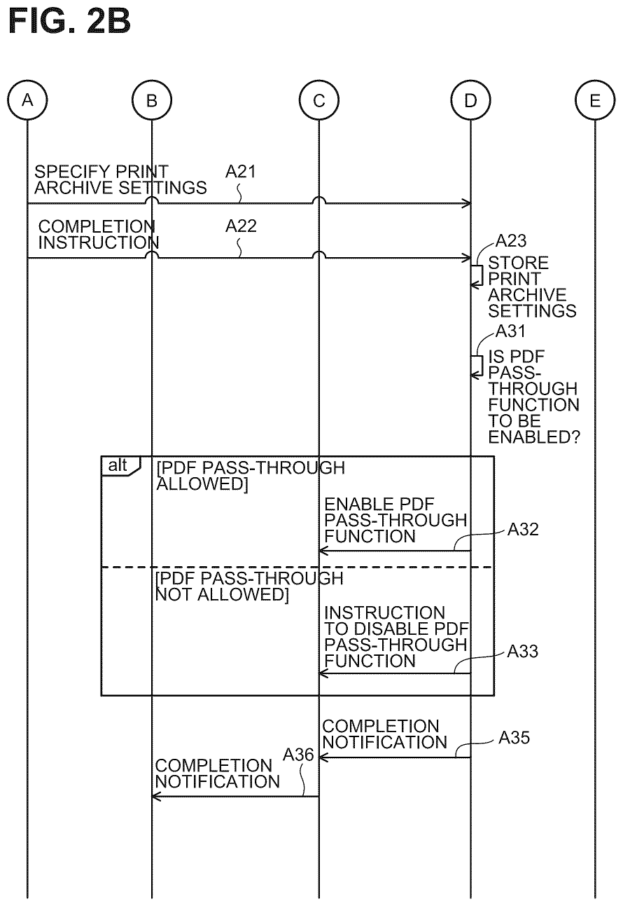

Reference to FIGS. 2A and 2B, a print settings specifying procedure will be described. The print settings specifying procedure is a part of the overall printing procedure. The editing application 43 allows the user to create or edit documents and images. In a case where the user is to print a document or image being displayed, the user selects “Print” on the editing application 43 (A01). For example, the user may select “Print” from a menu of operation items listed in the editing application 43.

In response to the user selecting “Print”, the editing application 43 requests the universal printing program 41 of the OS 21 to display a screen that allows the user to input an instruction relating to printing (A02). In response to the display request, the universal printing program 41 displays a print settings screen on the user IF 13 (A03). The print settings screen allows the user to specify print settings that are available to the universal printing program 41. In other embodiments, for example, displaying the print settings screen may be implemented by the editing application 43.

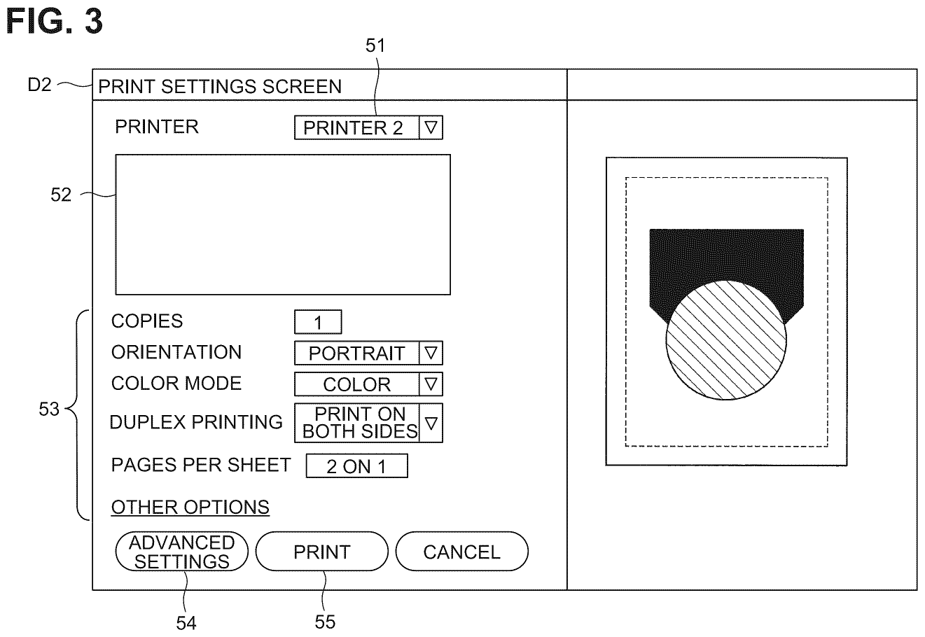

FIG. 3 illustrates an example of the print settings screen. An example print settings screen D2 includes a printer selection field 51, an information display field 52, basic print settings specification fields 53, an “advanced settings” button 54, and a “print” button 55. The printer selection field 51 allows the user to designate a device for printing. The information display field 52 displays information specified by the supporting program 42 for the device designated in the printer selection field 51. For example, in response to the designation of the printer 2 in the printer selection field 51 or in response to the reception of a print instruction through the “print” button 55 while the printer 2 is set as the default printer in the OS 21, the universal printing program 41 activates the supporting program 42 and displays an image prepared by the supporting program 42 in the information display field 52.

The basic print settings specification fields 53 allow the user to specify the basic settings such as the number of copies and page orientation. The “advanced settings” button 54 allows the user to activate advanced settings, including settings that are not included in the basic print settings specification fields 53. The “print” button 55 allows the user to activate printing under the specified print settings.

For example, in response to the advanced settings being activated through the “advanced settings” button 54 while the printer 2 is designated as the device for printing in the printer selection field 51 (A11), the universal printing program 41 transmits an instruction to the supporting program 42 for the printer 2 to start allowing the user to specify the advanced print settings (A12).

After the supporting program 42 is activated in response to receiving the instruction in step A12, the supporting program 42 obtains capabilities data of the printer 2. More specifically, the supporting program 42 requests the universal printing program 41 to obtain the capabilities data (A13). In response to receiving the request, the universal printing program 41 transmits a command to the printer 2 to request the capabilities data from the printer 2 (A14). The universal printing program 41 then passes the obtained capabilities data to the supporting program 42 (A15). The supporting program 42 thus obtains the capabilities data of the printer 2.

In step A14, the universal printing program 41 performs communication with the printer 2 via the OS 21 in accordance with, for example, the Internet Printing Protocol (“IPP”). In other embodiments, for example, the supporting program 42 may obtain the capabilities data directly from the printer 2 using, for example, the Management Information Base (“MIB”), instead of obtaining the capability data via the universal printing program 41.

The capabilities data obtained from the printer 2 includes parameters that can be specified as print settings. The capabilities data may further include, for example, remaining life of consumables, available trays, sheet sizes assigned to trays, and available image data formats. In other embodiments, for example, the printer 2 may have a function of performing image processing based on a received print job and performing printing using image data obtained from the image processing. The printing enabled by this function may be, for example, N-in-one printing, embedded printing such as printing with a watermark, or colorant saving printing. In a case where the printer 2 has an image processing function, the printer 2 may include the capability of the image processing in the capabilities data when providing the capabilities data to the supporting program 42 directly or indirectly. The printer 2 may provide the capabilities data including a status of the printer 2 to the supporting program 42 directly or indirectly.

Based on the obtained capabilities data, the supporting program 42 displays an advanced settings screen on the user IF 13 (A17). The advanced settings screen allows the user to specify advanced settings. The advanced settings screen displayed by the supporting program 42 includes parameters as options that the printer 2 supports. The supporting program 42 allows the user to specify one or more options through the displayed advanced settings screen. The advanced settings screen includes a relatively large number of settings for printing. Therefore, the advanced settings screen may include, for example, tabs that enable the user to switch between different setting items. The supporting program 42 may thus allow the user to select options by navigating through the tabs.

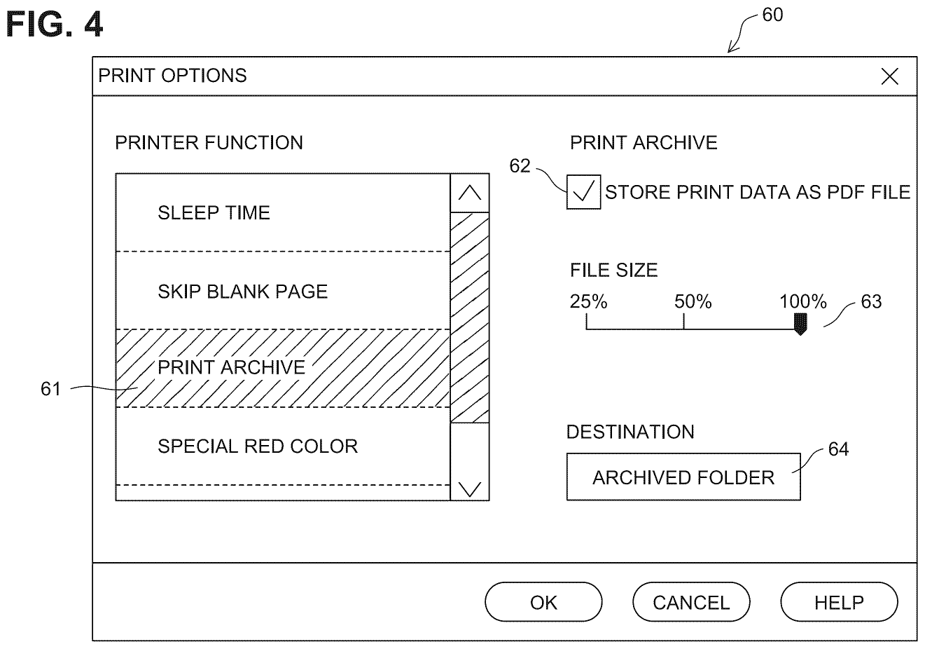

The supporting program 42 may activate Print Archive settings in response to a user request. The Print Archive function is one of optional functions of the supporting program 42. When the Print Archive function is enabled, data representing an image to be printed is stored in a predetermined storage area in response to a print instruction. In response to receiving the request for Print Archive settings, the supporting program 42 displays, on the user IF 13, a screen that allows the user to specify options for Print Archive settings. FIG. 4 illustrates an option settings screen 60 as an example of such a screen. The supporting program 42 allows the user to specify an option through the displayed option settings screen 60.

The option settings screen 60 illustrated in FIG. 4 indicates various options including an option 61 for specifying the Print Archive settings. In response to the option 61 being selected, the supporting program 42 displays a check box 62 that allows the user to enable or disable the Print Archive function, as illustrated in FIG. 4. In response to the check box 62 being checked, the Print Archive function becomes enabled. The supporting program 42 further displays a slider bar 63 for allowing the user to specify scale-down settings and a folder selection field 64 for allowing the user to specify a destination for storing the file to be archived.

When the Print Archive function is enabled by checking the check box 62, in response to receiving a print instruction, the supporting program 42 stores PDF data representing the image to be printed in a folder specified in the folder selection field 64. Allowing the user to select whether the image is to be stored by checking or unchecking the check box 62 is an example of receiving a selection indicating whether an image is to be stored.

The supporting program 42 allows the user to select whether a scaled-down image is stored, and to specify a scale-down factor if the option to store the scaled-down image is selected. The scaled-down image is a scaled-down version of the image to be printed. Allowing the user to specify a scaling factor using the slider bar 63 is an example of receiving a scaling factor via a user interface of the information processing device and an example of receiving a selection indicating whether the image to be printed is to be scaled down. By default, the supporting program 42 might not to scale down the image to be printed.

A greater degree of scaling down may reduce a load on the memory 12, but may result in a grainy image and lower image quality. The supporting program 42 allows the user to specify the scale-down factor. Therefore, a trade-off between the reduction of the load on the memory 12 and the deterioration of image quality may be adjusted according to an intended use of the image. The supporting program 42 may allow the user to specify the scale-down factor, for example, using a numerical value ranging from 0 to 100, or specifying a scale-down level such as high, medium, or low, instead of using the slider bar 63.

The destination for storing the file to be archived specified in the folder selection field 64 is an example of a predetermined storage area. In other embodiments, for example, the supporting program 42 may allow the user to specify another option, for example, a storage area of an external device as the destination for storing the file to be archived, instead of the memory 12 in the PC 1. Alternatively, the destination for storing the file to be archived may be determined in advance.

Referring back to FIG. 2B, the user provides an instruction to complete the print settings including the Print Archive settings by selecting an OK button (refer to FIG. 4). More specifically, receiving a completion instruction to complete the print settings from the user (A22) after the Print Archive settings are specified (A21) causes the supporting program 42 to dismiss the option settings screen 60 and store the specified print settings including the Print Archive settings (A23).

The universal printing program 41 allows the user to specify a PDF pass-through function when the image file to be printed is in PDF format. When the PDF pass-through function is enabled, the image file in PDF format is transmitted to the printer 2 without being processed. The supporting program 42 determines whether the PDF pass-through function is to be enabled in the universal printing program 41 based on the capabilities data received from the printer 2 and the advanced print settings received by the user's instruction (A31).

The universal printing program 41 does not activate the supporting program 42 when the PDF pass-through function is enabled in association with the supporting program 42 for the printer 2 and the universal printing program 41 has received a print instruction including PDF data as the image data to be printed. In this case, the universal printing program 41 does not generate intermediate image data or print data based on the image data to be printed. In other words, the universal printing program 41 transmits the PDF data to the printer 2 without any additional processing. Such a procedure omits conversion of the image data to be printed into intermediate image data, thereby reducing needless processing and deterioration of image quality due to the format conversion of the image to be printed. The PDF pass-through function is an example of a specific mode.

When the printer 2 supports PDF data and the Print Archive function is disabled, the supporting program 42 determines that the PDF pass-through function is allowed to be enabled. The printer 2 supporting PDF data may mean that the printer 2 is capable of receiving PDF data and performing printing based on the PDF data. The capabilities data of the printer 2 may include information on whether the printer 2 supports PDF data. The supporting program 42 may determine whether the printer 2 supports PDF data based on functionality of the model of the printer 2.

When the supporting program 42 determines that the PDF pass-through function is allowed to be enabled (alt: [PDF Pass-Through Function Allowed]), the supporting program 42 passes an instruction to enable the PDF pass-through function to the universal printing program 41 (A32). Step A32 is an example of allowing the universal printing program to be in the specific mode. When the universal printing program 41 receives such an instruction from the supporting program 42, the universal printing program 41 stores the enablement of the PDF pass-through function in association with the identification information of the supporting program 42.

When the printer 2 does not support PDF data or when the Print Archive function is enabled, the supporting program 42 determines that the PDF pass-through function is not allowed to be enabled. When the supporting program 42 determines that the PDF pass-through function is not allowed to be enabled (alt: [PDF Pass-Through Function Not Allowed]), the supporting program 42 passes an instruction to disable the PDF pass-through function to the universal printing program 41 (A33). Step A33 is an example of not allowing the universal printing program to be in the specific mode.

In a case where the PDF pass-through function has been enabled in association with the identification data of the supporting program 42, the universal printing program 41 disables the PDF pass-through function in response to receiving the instruction to disable the PDF pass-through function from the supporting program 42. In a case where the PDF pass-through function has been disabled, the universal printing program 41 might not perform any processing. In a case where the PDF pass-through function has been disabled, even if the image data to be printed is PDF data, the universal printing program 41 does not transmit the PDF data to the printer 2 without processing. More specifically, the universal printing program 41 generates intermediate image data and requests the supporting program 42 to perform particular processing on the intermediate image data.

When the PDF pass-through function is enabled, the universal printing program 41 does not generate intermediate image data and does not activate the supporting program 42. Therefore, the supporting program 42 is not allowed to save the image data for the Print Archive function. When the Print Archive function is enabled, the supporting program 42 disables the PDF pass-through function. Thus, the supporting program 42 is allowed to cause the universal printing program 41 to generate intermediate image data and activate the supporting program 42.

Then, the supporting program 42 provides a completion notification that the specification of the advanced settings has been completed to the universal printing program 41 (A35). Based on the completion notification from the supporting program 42, the universal printing program 41 provides a completion notification that the specification of the print settings has been completed to the editing application 43 (A36). In other embodiments, for example, the supporting program 42 may provide the print settings completion notification directly to the editing application 43. The editing application 43 thus activates the print settings screen (e.g., the print settings screen D2 of FIG. 3) displayed in step A03, thereby allowing the user to input instructions, such as an instruction to perform printing or an instruction to cancel printing.

As described above, the print settings screen D2 (refer to FIG. 3) includes the information display field 52 capable of displaying an image generated by the supporting program 42. In response to receiving user input in the information display field 52, the universal printing program 41 passes details of the input to the supporting program 42. For example, the supporting program 42 may display, in the information display field 52, a screen that allows the user to specify the Print Archive settings. The supporting program 42 thus allows the user to specify the Print Archive settings through such a screen in the information display field 52. In this case, also as with step A23, the supporting program 42 stores the Print Archive settings.

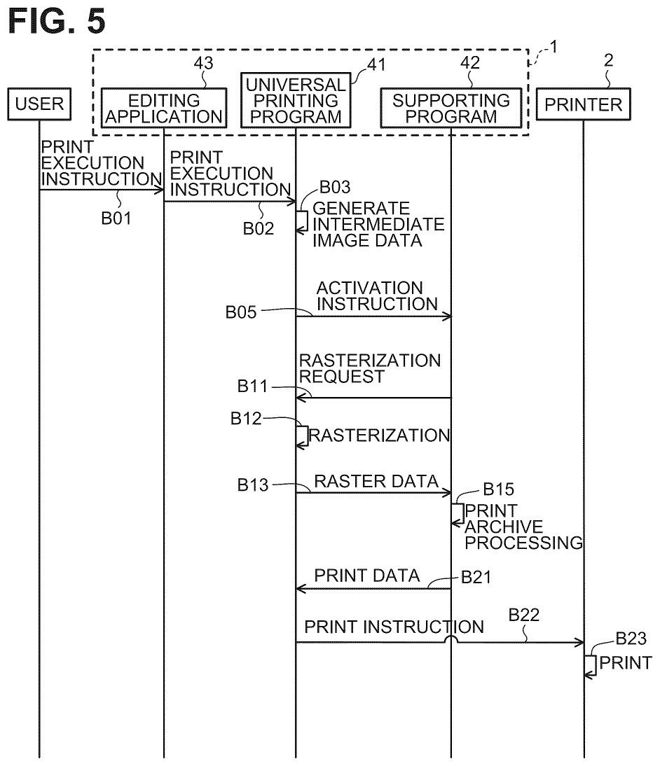

Next, a print execution procedure will be described with reference to FIG. 5. After finalizing the image to be printed and the print settings for the printer 2, the user issues a print execution instruction via the editing application 43 (B01). More specifically, for example, based on the user's selection of the “Print” button 55 in the print settings screen D2 of FIG. 3, the editing application 43 determines that a print execution instruction for the universal printing program 41 has been received. The print execution instruction instructs the printer 2 to print the specified image. Referring to FIG. 5, a description will be provided on a case where a print instruction including the Print Archive settings is received. The print execution instruction from the user may be directly input to the universal printing program 41.

The editing application 43 passes the details of the print execution instruction to the universal printing program 41 (B02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (B03). The image data included in the editing application 43 is of various types. The universal printing program 41 thus converts the received image data to intermediate image data suitable for generating print data. Nevertheless, in other embodiments, for example, when the received image data is in a suitable format, the generation of intermediate image data may be omitted, and the image data may be used as intermediate image data without any conversion.

Prior to generating the intermediate image data, the universal printing program 41 may activate the supporting program 42 for the designated device, which may be the printer 2, and notify that processing for a print job has been started. In a case where the supporting program 42 is activated by the universal printing program 41, the supporting program 42 is allowed to pass various instructions to be used in the generation of intermediate image data, to the universal printing program 41 as necessary.

After generating the intermediate image data, the universal printing program 41 activates the supporting program 42 (B05). The supporting program 42 may obtain the intermediate image data generated by the universal printing program 41 by requesting the intermediate image data from the universal printing program 41. Then, the supporting program 42 may modify the intermediate image data and the print settings based on the received advanced print settings.

As described above, when the Print Archive function is enabled, the supporting program 42 passes the instruction not disable the PDF pass-through function to the universal printing program (A33 in FIG. 2B). Thus, in the procedure of FIG. 5, the universal printing program 41 generates and passes intermediate image data to the supporting program 42 even when the image data representing the image to be printed received from the editing application 43 is PDF data.

In response to receiving an activation instruction, the supporting program 42 requests the universal printing program 41 to perform rasterization (B11). Based on the request, the universal printing program 41 rasterizes the intermediate image data to generate raster data (B12). The raster data may be bitmap data. Subsequent to step B12, the universal printing program 41 passes the generated raster data to the supporting program 42 (B13). Thus, the supporting program 42 obtains the raster data. The raster data received by the supporting program 42 from the universal printing program 41 is an example of intermediate data.

In the illustrative embodiment, the supporting program 42 requests the universal printing program 41 to perform rasterization. Nevertheless, in other embodiments, for example, the supporting program 42 may perform rasterization. However, rasterization by the universal printing program 41 may enable the supporting program 42 to execute less processing, and may reduce the program size of the supporting program 42.

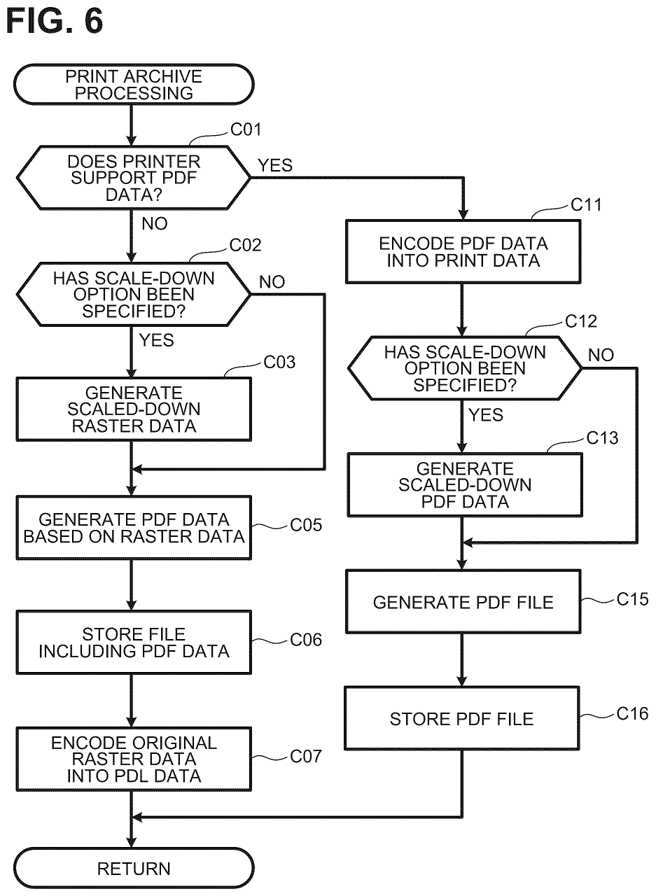

Subsequent to step B13, the supporting program 42 executes Print Archive processing (B15). The Print Archive processing will be described with reference to FIG. 6. The Print Archive processing is executed by the CPU 11 of the PC 1 based on the supporting program 42.

The CPU 11 determines whether the printer 2 supports PDF data (C01). For example, the information on whether the printer 2 supports PDF data is included in the capabilities data of the printer 2 received in step A15 of FIG. 2A.

If the CPU 11 determines that the printer 2 does not support PDF data (C01: NO), the CPU 11 determines whether a scale-down option has been specified as the Print Archive settings (C02). If the CPU 11 determines that the scale-down option has been specified (C02: YES), the CPU 11 generates scaled-down raster data (C03). More specifically, the CPU 11 generates a copy of the raster data received from the universal printing program 41 in step B13 of FIG. 5, and then scales down the copy of the raster data at the scale-down factor specified by the user. The scale-down factor may be specified using the slider bar 63 of the option settings screen 60 (refer to FIG. 4).

Subsequent to step C03 or if the CPU 11 determines that the scale-down option has not been specified (C02: NO), the CPU 11 generates PDF data for storage (C05). More specifically, the CPU 11 generates PDF data for storage based on the scaled-down raster data generated in step C03 or the copy of the raster data received from the universal printing program 41 in step B13 of FIG. 5. Step C05 is an example of obtaining image data in specific file format. The PDF data for storage is an example of image data in a specific file format.

That is, in a case where the CPU 11 generates the scaled-down raster data in step C03 in response to the scale-down instruction, the CPU 11 generates PDF data representing a scaled-down image in step C05. The scaled-down image is a scaled-down version of the image to be printed. The PDF data representing the scaled-down image is an example of first PDF data. Generating and storing PDF data representing the scaled-down image may reduce the file size of the PDF data to be stored, thereby reducing a load on the memory 12. When a scale-down instruction has not been received, the CPU 11 generates, in step C05, PDF data representing the image to be printed without scaling down. The PDF data representing the unscaled image is an example of second PDF data.

Subsequent to C05, the CPU 11 stores a file including the generated PDF data for storage in the destination specified by the user (C06). Step C06 is an example of storing the image data in the specific file format in a predetermined storage area. The destination may be specified using the folder selection field 64 of the option settings screen 60 (refer to FIG. 4).

Subsequent to step C06, the CPU 11 encodes the original raster data into print data including PDL data (C07). The original raster data may be raster data received from the universal printing program 41. The PDL data is in a format that is supported by the printer 2. When the printer 2 does not support PDF data, the CPU 11 generates PDF data for storage in addition to PDL data for printing. When the scale-down option has been specified, the CPU 11 generates scaled-down PDF data for storage based on the raster data. Thus, the generated PDF data can be used for both printing and storage as reduced file size.

If the CPU 11 determines that the printer 2 supports PDF data (C01: YES), the CPU 11 generates PDF data, which is image data in PDF format, based on the raster data received from the universal printing program 41 in step B13 of FIG. 5, and encodes the PDF data into print data including the PDF data (C11). The PDF data generated in step C11 is an example of third PDF data.

The CPU 11 determines whether the scale-down option has been specified as the Print Archive settings (C12). If the CPU 11 determines that the scale-down option has been specified (C12: YES), the CPU 11 generates scaled-down PDF data (C13). More specifically, the CPU 11 generates a copy of the PDF data generated in step C11, and then scales down the copy of the PDF data at the scale-down factor specified by the user.

Subsequent to step C13 or if the CPU 11 determines that the scale-down option has not been specified (C12: NO), the CPU 11 generates a PDF file for storage (C15). More specifically, in a case where the CPU 11 generates the scaled-down PDF data in step C13, the CPU 11 generates a PDF file for storage including the scaled-down PDF data. In a case where the CPU 11 determines that the scale-down option has not been specified, the CPU 11 generates a PDF file for storage including the copy of the PDF data generated in step C11. Step C15 is an example of obtaining image data in specific file format. The PDF file for storage is another example of the image data in the specific file format.

In a case where the printer 2 supports PDF data, the PDF data for storage may be used for printing. In this case, the processing load may be reduced as compared with a case where the PDL data for printing is generated in addition to the PDF data for storage. When the printer 2 supports PDF data and the scale-down option is specified, the CPU 11 generates scaled-down PDF data for storage and PDF data for printing. This allows each data to be used for printing or for storage as reduced file size.

Subsequent to step C15, the CPU 11 stores the generated PDF file in the destination specified by the user as the Print Archive settings (C16). Step C16 is an example of storing the image data in the specific file format in a predetermined storage area. After step C07 or C16, the CPU 11 ends the Print Archive processing and the process returns to the print execution procedure of FIG. 5.

Referring back to FIG. 5, the supporting program 42 passes print data to the universal printing program 41 and instructs the universal printing program 41 to transmit the print data to the printer 2 (B21). The print data may include the PDL data generated in step C07 or the PDF data generated in step C11 of the Print Archive processing. Step B21 is an example of causing the printer 2 to perform printing.

In response to the instruction from the supporting program 42, the universal printing program 41 transmits the print data including the PDL data or the PDF data to the printer 2 and instructs the printer 2 to perform printing (B22). In response to this, the printer 2 performs printing based on the received print data (B23). Thus, a printed matter having the image to be printed is outputted. When the printer 2 supports printing based on PDF data, the printer 2 receives the PDF data in step B22, analyzes the PDF data, and then performs printing.

In a case where the supporting program 42 receives a print instruction not including the Print Archive settings, the supporting program 42 does not execute the Print Archive processing. Thus, the supporting program 42 does not generate a file for storage and does not perform file storing. In this case, the supporting program 42 generates print data based on the raster data received from the universal printing program 41 in step B13. The supporting program 42 then passes the generated print data to the universal printing program 41 and instructs the universal printing program 41 to transmit the print data to the printer 2.

Storing the image data based on the Print Archive instruction may allow the user to review the print content but may increase a load on the CPU 11 and the memory 12. The PC 1 allows the user to select whether to store the image data, thereby avoiding unnecessary processing or unnecessary use of the memory 12 when the image data does not need to be stored.

In the illustrative embodiment, the supporting program 42 provides the print data to the printer 2 via the universal printing program 41. Nevertheless, in other embodiments, for example, the supporting program 42 may provide a print instruction to instruct print execution and print data directly to the printer 2. In still other embodiments, for example, in a case where the print settings include settings for image processing that can be executed by the printer 2, the supporting program 42 may generate a print instruction including the settings for image processing. In this case, after completing the transmission of the print data, the supporting program 42 may notify the universal printing program 41 of the completion of the print data transmission.

In the illustrative embodiment, the universal printing program 41 does not activate the supporting program 42 when the universal printing program 41 receives a print instruction including PDF data while the PDF pass-through function is enabled. Nevertheless, in other embodiments, for example, when the universal printing program 41 receives a print instruction including PDF data while the PDF pass-through function is enabled, the universal printing program 41 may activate the supporting program 42. More specifically, for example, the universal printing program 41 may pass the PDF data to the supporting program 42 without generating intermediate image data or print data based on the PDF data. Hereinafter, a description will be provided on a procedure in a case where the universal printing program 41 is configured to activate the supporting program 42 and pass PDF data when the universal printing program 41 receives a print instruction including the PDF data while the PDF pass-through function is enabled.

In step A31 of FIG. 2B, the supporting program 42 determines, based on the capabilities of the printer 2, whether the PDF pass-through function is to be enabled, regardless of whether the Print Archive settings are specified. More specifically, the supporting program 42 determines whether the printer 2 supports PDF data. If the printer 2 supports PDF data, the supporting program 42 determines that the PDF pass-through function is allowed to be enabled. If the printer 2 does not support PDF data, the supporting program 42 determines that the PDF pass-through function is not allowed to be enabled. In a case where the printer 2 supports PDF data, the supporting program 42 transmits an instruction to enable the PDF pass-through function to the universal printing program 41 (A32 in FIG. 2B). In a case where the printer 2 does not support PDF data, the supporting program 42 transmits an instruction to disable the PDF pass-through function to the universal printing program 41 (A33 in FIG. 2B).

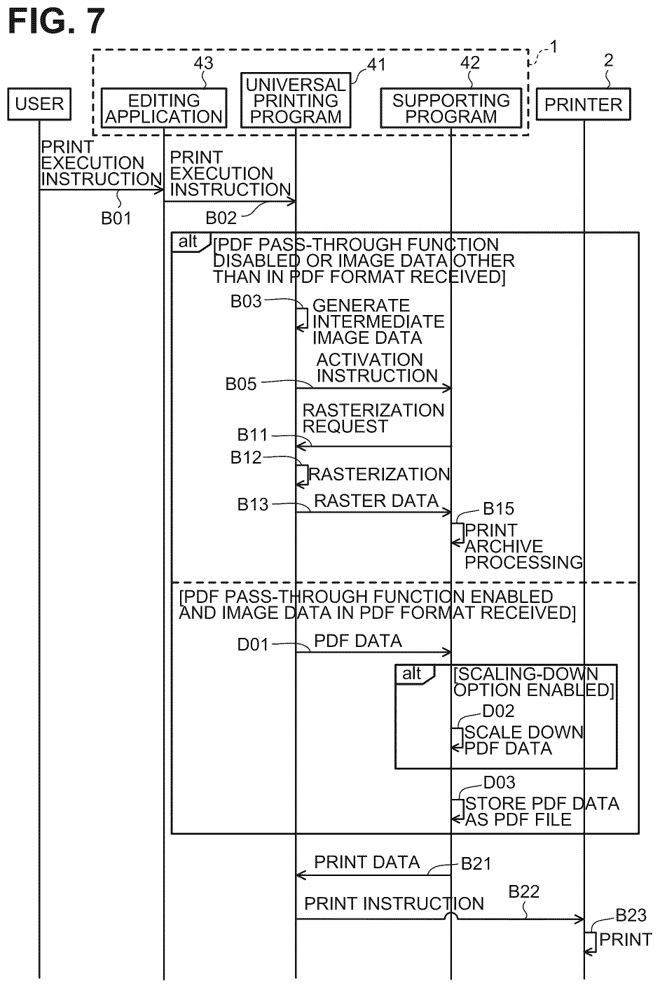

Referring to FIG. 7, a description will be provided on a print execution procedure in a case where the universal printing program 41 is configured as described above and the PDF pass-through function is enabled based on the capabilities of the printer 2. In the following description, the same reference numerals are used for the same steps as those in the sequence diagram of FIG. 5, and a description thereof will be simplified accordingly.

The user inputs a print execution instruction via the editing application 43 (B01). The editing application 43 passes the details of the print execution instruction to the universal printing program 41 (B02).

In a case where the PDF pass-through function is disabled or the received image data is not PDF data (alt: [PDF Pass-Through Function Disabled or Image Data other than in PDF Format Received]), the universal printing program 41 generates intermediate image data (B03) and activates the supporting program 42 (B05), as in the procedure of FIG. 5. In this case, the supporting program 42 requests the universal printing program 41 to perform rasterization (B11). In response to this, the supporting program 42 receives raster data from the universal printing program 41 (B13), and executes the Print Archive processing of FIG. 6 (B15), as in the procedure of FIG. 5.

In a case where the PDF pass-through function is enabled and the received image data is PDF data (alt: [PDF Pass-Through Function Enabled and Image Data in PDF Format Received]), the universal printing program 41 activates the supporting program 42 and passes an execution instruction including the PDF data to the supporting program 42 (D01).

The supporting program 42 determines whether the scale-down option has been specified as the Print Archive settings. If the CPU 11 determines that the scale-down option has been specified (alt: [Scale-Down Option Enabled]), the CPU 11 generates scaled-down PDF data (D02). More specifically, the CPU 11 generates a copy of the received PDF data, and then scales down the copy of the PDF data at the scale-down factor specified by the user. Thus, scaled-down image data representing the scaled-down image is generated. The scaled-down image is a scaled-down version of the image to be printed, which is represented by the PDF data.

Subsequent to step D03, the supporting program 42 stores the copy of the PDF data received in step D01 or the PDF data scaled down in step D02, as a PDF file, in the destination specified by the user in the Print Archive settings (D03). Step D03, in which the PDF data received in step D01 is stored, is an example of storing the image data in the specific file format received from the universal printing program in the predetermined storage area without being processed. Step D03, in which the PDF data scaled down in step D02, is an example of storing scaled image data in the specific file format based on the image data in the specific file format received from the universal printing program.

The supporting program 42 passes the print data generated in the Print Archive processing in step B15 or the PDF data received in step D01 to the universal printing program 41 as print data, and instructs the universal printing program 41 to transmit the print data to the printer 2 (B21). Step B21 in this case is also an example of causing the printer 2 to perform printing. Step B21, in which the PDF data received in step D01 is transmitted to the universal printing program 41, is an example of causing the printer to perform printing based on the image data in the specific file format received from the universal printing program. In response to the instruction from the supporting program 42, the universal printing program 41 transmits the print data to the printer 2 and instructs the printer 2 to perform printing (B22). In response to the print instruction, the printer 2 performs printing based on the received print data (B23).

As described above, in response to receiving the intermediate image data representing the image to be printed from the universal printing program 41 of the OS 21, based on the intermediate image data, the supporting program 42 performs processing for causing the printer 2 to print the image to be printed, and also obtains PDF data and stores the PDF data in the predetermined storage area. With this configuration, even when the PC 1 does not have a printer driver installed and printing is performed through the universal printing program 41, the PC 1 may store PDF data representing the image to be printed. In addition, the supporting program 42 stores a file including PDF data, thereby enabling the user to easily use the stored image data. In other words, the supporting program 42 stores the image data in PDF format, thereby enabling the user to easily use the stored image data.

While the disclosure has been described in detail with reference to the specific embodiment thereof, this is merely an example, and various changes, arrangements and modifications may be applied therein without departing from the spirit and scope of the disclosure. Apparatuses or devices connected to the PC 1 are not limited to printers only having a printing function. Any apparatuses or devices having a printing function may be connected to the PC 1. Examples of such apparatuses or devices include multifunction peripherals, copying machines, and facsimile machines. A plurality of printers, for example, two or more printers may be connected to the PC 1.

The screens illustrated in the illustrative embodiment are all examples. The words or indications on the screens and the screen layouts, such as the shapes of the objects and the backgrounds on the screen, illustrated in the illustrative embodiment are all examples. For example, FIG. 3 illustrates the print settings screen D2 including a single information display field 52. Nevertheless, the location, shape, size, and/or the number of information display fields 52 are not limited to the example of the illustrative embodiment. The print settings screen D2 might not necessarily include the information display field 52.

The file format for storing image data may be any format different from that of intermediate image data, and is not limited to the PDF format. The image data for storage may be in formats such as JPEG, PNG, or bitmap. The supporting program 42 may allow the user to specify the file format of the image data for storage.

The supporting program 42 may obtain the capabilities data of the printer 2 at a timing different from the example illustrated in FIG. 2A. In one example, the supporting program 42 may obtain the capabilities data after receiving an Print Archive instruction. In another example, the supporting program 42 may obtain the capabilities data again after receiving a print execution instruction.

In a case where the scale-down settings have been specified, the supporting program 42 scales down raster data or PDF data. Nevertheless, in other embodiments, for example, the universal printing program 41 may scale down such data. In still another example, the supporting program 42 may obtain raster data for a scaled-down image from the universal printing program 41. In this case, the universal printing program 41 may perform rasterization for generating raster data for a scaled-down image, separately from the rasterization for generating raster data for printing.

The supporting program 42 may be activated not only when the “Print” button is selected but also when the printer 2 is specified is the device settings, for example. In this case as well, the supporting program 42 may display a setting screen that allows the user to specify the Print Archive settings. In a case where the supporting program 42 receives the Print Archive settings as the device settings, the supporting program 42 stores the received Print Archive settings as the default print settings.

In other embodiments, for example, the universal printing program 41 may also activate the supporting program 42 in a case where the default printer is changed to the printer 2 through the OS 21 by a user's operation after the universal printing program 41 displays the print settings screen D2 (refer to FIG. 3). In this case as well, for example, the supporting program 42 may display a particular screen that allows the user to specify the Print Archive settings in the information display field 52.

In the illustrative embodiment, the description has been provided on only the printing operation in which the supporting program 42 is involved. However, the supporting program 42 may be involved in another operation in addition to the printing operation. Any program may be applicable instead of the supporting program 42, as long as the program receives an instruction from the OS 21 or the universal printing program 41 when printing is performed using the universal printing program 41. For example, the alternative program may be a print workflow application (PrintWorkflow) whose specification has been disclosed by Microsoft Corporation.

The manner for activating the supporting program 42 is not limited to the examples in the illustrative embodiment. In one example, the supporting program 42 may be activated in response to an activation instruction received directly from the OS 21. In another example, the supporting program 42 may be a resident program. In a case where the supporting program 42 is a resident program, the supporting program 42 may be configured to behave as described above in response to an activation instruction.

In any flowchart disclosed in the illustrative embodiment, steps may be executed in a different order or in parallel, as long as no contradiction occurs in the contents of the procedures.

The processing in all steps disclosed in the illustrative embodiment may be executed by a single CPU, a plurality of CPUs, hardware, for example, an ASIC, or a combination a CPU and an ASIC. The processing in all steps disclosed in the embodiment may be implemented in various aspects such as a recording medium storing a computer-readable program for executing the processing, or a method.

What is claimed is:

1. A non-transitory computer-readable storage medium for an information processing device, the information processing device including a controller, the non-transitory computer-readable storage medium storing computer-executable instructions for implementing a supporting program for a printer connectable to the information processing device,
wherein the information processing device has an operating system including a universal printing program, the information processing device is incorporated with an application program, and
wherein, in a case where the supporting program receives, from the universal printing program, intermediate data representing an image to be printed based on a print instruction in response to the universal printing program receiving, from the application program, the print instruction that causes the printer to perform printing, the supporting program, that when executed by the controller, causes the information processing device to perform:
obtaining image data in specific file format based on the intermediate data, the image data representing the image to be printed, the specific file format being different from a file format of the intermediate data;
storing the image data in the specific file format in a predetermined storage area; and
causing the printer to print the image to be printed based on the intermediate data.

2. The non-transitory computer readable storage medium according to claim 1, wherein the obtaining the scaled data includes obtaining the image data representing a scaled image based on the intermediate data, the scaled image being a scaled-down version of the image to be printed.

3. The non-transitory computer readable storage medium according to claim 2,
wherein the supporting program, when executed by the controller, causes the information processing device to perform:
receiving a scaling factor via a user interface of the information processing device, and
wherein the obtaining the scaled data includes obtaining the image data representing a scaled image based on the intermediate data, the scaled image being a scaled-down version of the image to be printed that has been scaled down at the received scaling factor.

4. The non-transitory computer readable storage medium according to claim 1, wherein the supporting program, when executed by the controller, causes the information processing device to perform:
receiving a selection indicating whether the image to be printed is to be scaled down, via a user interface of the information processing device;
in response to receiving the selection indicating that the image to be printed is to be scaled down, obtaining the image data representing a scaled image based on the intermediate data, the scaled image being a scaled-down version of the image to be printed; and
in response to receiving the selection indicating that the image to be printed is not to be scaled down, obtaining the image data based on the intermediate data, the image data representing the image to be printed without scaling down.

5. The non-transitory computer readable storage medium according to claim 1,
wherein the obtaining the scaled data includes obtaining PDF data based on the intermediate data, the PDF data being the image data in PDF file format, the specific file format including the PDF file format, and
wherein the storing the image data includes storing the PDF data in the predetermined storage area.

6. The non-transitory computer readable storage medium according to claim 5,
wherein the causing the printer to print the image to be printed includes:
in a case where the printer supports the PDF file format, transmitting the PDF data to cause the printer to print the image to be printed; and
in a case where the printer does not support the PDF file format,
generating PDL data based on the intermediated data, the PDL data being in a file format that is supported by the printer; and
transmitting the PDL data to the printer to cause the printer to print the image to be printed.

7. The non-transitory computer readable storage medium according to claim 1,
wherein the supporting program supports the printer that supports the PDF file format,
wherein the supporting program, when executed by the controller, causes the information processing device to perform:
receiving a selection indicating whether the image to be printed is to be scaled down, via a user interface of the information processing device;
in response to receiving the selection indicating that the image to be printed is to be scaled down, obtaining first PDF data in the specific file format based on the intermediate data, the first PDF data representing the image data being a scaled-down version of the image to be printed, the specific file format being the PDF file format; and
in response to receiving the selection indicating that the image to be printed is not to be scaled down, obtaining second PDF data in the specific file format based on the intermediate data, the second PDF data representing the image data representing the image to be printed without scaling down, the specific file format being the PDF file format, and
wherein the causing the printer to print the image to be printed includes:
in response to receiving the selection indicating that the image to be printed is not to be scaled down, transmitting the second PDF data to cause the printer to print the image to be printed; and
in response to receiving the selection indicating that the image to be printed is to be scaled down,
obtaining third PDF data based on the intermediate data, the third PDF data being the image data in the PDF file format representing the image to be printed without scaling down; and
transmitting the third PDF data to the printer to cause the printer to print the image to be printed.

8. The non-transitory computer readable storage medium according to claim 1,
wherein the supporting program supports the printer that does not support the PDF file format,
wherein the supporting program, when executed by the controller, causes the information processing device to perform:
receiving a selection indicating whether the image to be printed is to be scaled down, via a user interface of the information processing device;
in response to receiving the selection indicating that the image to be printed is to be scaled down, obtaining first PDF data in the specific file format based on the intermediate data, the first PDF data representing the image data being a scaled-down version of the image to be printed, the specific file format being the PDF file format; and
in response to receiving the selection indicating that the image to be printed is not to be scaled down, obtaining second PDF data in the specific file format based on the intermediate data, the second PDF data representing the image data representing the image to be printed without scaling down, the specific file format being the PDF file format, and
wherein the causing the printer to print the image to be printed includes:
generating PDL data based on the intermediate data, the PDL data being supported by the printer; and
transmitting the third PDL data to the printer to cause the printer to print the image to be printed.

9. The non-transitory computer readable storage medium according to claim 1,
wherein the supporting program, when executed by the controller, causes the information processing device to perform:
receiving a selection indicating whether the image to be printed is to be scaled down, via a user interface of the information processing device;
in response to receiving the selection indicating that the image to be printed is to be scaled down, obtaining first PDF data in the specific file format based on the intermediate data, the first PDF data representing the image data being a scaled-down version of the image to be printed, the specific file format being the PDF file format; and
in response to receiving the selection indicating that the image to be printed is not to be scaled down, obtaining second PDF data in the specific file format based on the intermediate data, the second PDF data representing the image data representing the image to be printed without scaling down, the specific file format being the PDF file format, and
wherein the causing the printer to print the image to be printed includes:
determining whether the printer supports the PDF file format;
in response to determining that the printer supports the PDF file format and receiving the selection indicating that the image to be printed is not to be scaled down, transmitting the second PDF data to the printer;
in response to determining that the printer supports the PDF file format and receiving the selection indicating that the image to be printed is to be scaled down,
obtaining third PDF data based on the intermediate data, the third PDF data being the image data in the PDF file format representing the image to be printed without scaling down; and
transmitting the third PDF data to the printer to cause the printer to print the image to be printed; and
in response to determining that the printer does not support the PDF file format,
generating PDL data based on the intermediate data, the PDL data being supported by the printer; and
transmitting the third PDL data to the printer to cause the printer to print the image to be printed.

10. The non-transitory computer readable storage medium according to claim 1, wherein the supporting program, when executed by the controller, causes the information processing device to perform:
receiving a selection indicating whether an image is to be stored, via a user interface of the information processing device;
in response to receiving the print instruction,
in a case where the selection indicating that the image is to be stored has been received, performing the obtaining the image data in the specific file format, the storing the image data, and the causing the printer to print; and
in a case where the selection indicating that the image is not to be stored has been received, performing the causing the printer to print and not performing the obtaining the image data in the specific file format and the storing the image data.

11. The non-transitory computer readable storage medium according to claim 10,
wherein the universal printing program is enabled to be in a specific mode,
wherein, in response to the universal printing program receiving, by the print instruction, data in the specific file format as data representing the image to be printed from the application program:
in a case where the universal printing program is not in the specific mode, the universal printing program generates the intermediate data based on the received data and passes the intermediate data to the supporting program; and
in a case where the universal printing program is in the specific mode, the universal printing program transmits the received data to the printer without generating the intermediate data,
wherein the supporting program, when executed by the controller, causes the information processing device to:
in a case where the selection indicating that the image is not to be stored is received and the printer supports the specific file format, allow the universal printing program to be in the specific mode;
in a case where the selection indicating that the image is to be stored is received, not allow the universal printing program to be in the specific mode.

12. The non-transitory computer readable storage medium according to claim 1,
wherein the supporting program, when executed by the controller, causes the information processing device to perform, in a case where:
the universal printing program receives, from the application program, the print instruction that causes the printer to print an image;
the supporting program receives, from the universal printing program, image data in the specific file format representing the image to be printed by the print instruction; and
the printer supports the specific file format,
storing the image data in the specific file format received from the universal printing program in the predetermined storage area without being processed; and
causing the printer to perform printing based on the image data in the specific file format received from the universal printing program.

13. The non-transitory computer readable storage medium according to claim 1,
wherein the supporting program, when executed by the controller, causes the information processing device to perform, in a case where:
the universal printing program receives, from the application program, the print instruction that causes the printer to print an image;
the supporting program receives, from the universal printing program, image data in the specific file format representing the image to be printed by the print instruction; and
the printer supports the specific file format,
storing scaled image data in the specific file format based on the image data in the specific file format received from the universal printing program, the scaled image data representing a scaled-down version of the image to be printed; and
causing the printer to perform printing based on the image data in the specific file format received from the universal printing program.
